(19) United States
(12) Patent Application Publication
(10) Pub. No.: US 2007/0184732 A1
(43) Pub. Date: Aug. 9, 2007

(54) High strength polyvinyl acetate binders

(76) Inventors: David J. Lunsford, Simpsonville, SC (US); Cindy Dressendofer, Inman, SC (US); Rajeev Farwaha, Belle Mead, NJ (US); Phillip W. Davis, Simpsonville, SC (US)

Correspondence Address: FERRELLS, PLLC, P. O. BOX 312, CLIFTON, VA, 20124-1706, US

(21) Appl. No.: 11/348,895

(22) Filed: Feb. 7, 2006

(51) Int. Cl. B32B 5/02

(52) U.S. Cl. 442/59; 442/149; 442/152; 442/154

(57) ABSTRACT

A binder composition for fibrous substrates that includes a low-pressure polymerized emulsion resin comprising vinyl acetate monomer units and post-crosslinking monomer composition. The inventive compositions enable fibrous substrates with high tensile strengths and excellent curability, and are particularly useful as binders in synthetic fiberfill applications.

### TECHNICAL FIELD

The present invention relates generally to high strength emulsion binders for fibrous substrates. Binder compositions are provided that contain a polyvinyl acetate resin with a high level of post-crosslinking monomer that is polymerized onto the polymer backbone. These types of compositions are useful, for example, as binders for fiberfill products.

### BACKGROUND OF THE INVENTION

Polyvinyl acetate-type emulsion polymers are commonly used as binders in the nonwoven and textile industries to add strength to fibrous substrates. Specifically, it is known to use binding compositions that employ vinyl acetate polymers which are polymerized with post-crosslinking monomers, such as N-methylol acrylamide (“NMA”). The post-crosslinking monomer units in the binder react with themselves upon drying/curing to create crosslinking moieties throughout the binder. Accordingly, the binders provide elevated tensile strength properties when applied to a fibrous substrate.

However, in order for the self-crosslinking monomer to be effective at enhancing the strength properties of the fibrous substrate, it must be polymerized onto the polymer backbone. The inability to incorporate the post-crosslinking monomer onto the polymer backbone at high concentrations has been a persistent problem in the field of polyvinyl acetate emulsion polymerization. Conventional vinyl acetate products on the market contain effective post-crosslinking monomer levels in the range of about 2.5-4.0% due to the difficulty of polymerizing the crosslinking monomer in larger amounts. As larger amounts of post-crosslinking monomer are added to the reaction mix, the excess crosslinking monomer has a tendency to enter the water phase of the emulsion rather than being incorporated into the polymer backbone. This is problematic because binders are produced with limited tensile strength capabilities, even though large amounts of crosslinking monomer may have been added to the reaction mix. Additionally, the unpolymerized crosslinking monomer increases the viscosity of the emulsion to prohibitive levels. See, for example, U.S. Pat. No. 5,540,987 to Mudge et al. which discloses specific embodiments of ethylene/vinyl acetate (“EVA”) emulsion binders with about 3-5 percent of NMA monomers.

U.S. Patent Application Publication No. 2004/0147190 and European Patent No. 1443079, both to Goldstein et al., specifically discuss the problems that are encountered when polymerizing post-crosslinking monomers in large amounts. See, e.g., '190 Goldstein et al. publication at paragraph 003. The Goldstein et al. references disclose binder compositions that are a blend of a water dispersible polymer and a homopolymer of crosslinking monomers, where the blend is stated to have enhanced wet strength capabilities.

Other approaches to improve the strength properties of EVA resins can be seen in U.S. Pat. No. 4,590,102 to Rosamilia et al. The Rosamilia et al. reference discloses a process for curing EVA/NMA resins whereby an acid catalyst is added to the resin and it is briefly cured at low temperatures followed by an extended drying period at room temperature. The procedure is said to provide a full cure and save on energy requirements. U.S. Pat. No. 4,698,384 to Mao discloses a vinyl acetate/ethylene/NMA copolymer emulsion that contains a minor amount of polyvinyl pyrrolidone (“PVP”). The PVP is stated to provide increased tensile strength to the fibrous web and improve the solvent resistance of the web.

Attempts to increase the level of crosslinking monomers in EVA type emulsion resins were successful in Applicant's copending application Ser. No. 10/327,331 where effective NMA levels of from 7-9 percent are disclosed. While the binders produced according to the '331 application provide high strength values to fibrous webs, they are generally useful in applications where “soft” EVA-type resins are preferred. Additionally, the binders in the '331 application are polymerized using a process where the reactor must be pressurized to incorporate the ethylene. Indeed, the need for a pressurized reactor is common to virtually all EVA emulsion polymerization processes.

Polyvinyl acetate (“PVAc”) resins that are substantially free of ethylene may be polymerized at low pressures. However, ethylene-free vinyl acetate resins have also experienced significant problems with incorporating post-crosslinking monomers onto the polymer backbone.

U.S. Pat. No. 5,252,663 to Chandran et al. discloses some ethylene-free vinyl acetate resins which are reportedly useful in fiberfill applications. Examples 15 and 17 in the '663 patent disclose a polymer having 100 pphwm vinyl acetate and about 3-3.5 pphwm of crosslinking composition. While polymers of this type are known in the art, these resins are polymerized with conventional processes and would not provide significant strength properties.

Other approaches to increase the strength capabilities of polyvinyl acetate binders can be seen in U.S. Pat. No. 5,087,487 to Katz et al. The '487 Katz et al. reference discloses polyvinyl acetate emulsion binders having pre-crosslinking compounds such as triallyl cyanurate, and about 3 percent of post-crosslinking monomers such as N-methylol acrylamide (“NMA”). U.S. Pat. No. 5,190,997 to Lindemann et al. discloses a binder composition that is an interconnecting network of two polymers, with specific embodiments comprising networks of vinyl acetate and styrene polymers. Here again, the vinyl acetate polymer contains both pre-crosslinking monomers and post-crosslinking monomers.

Additional references of interest include U.S. Pat. No. 5,534,341 to Baines et al. and U.S. Pat. No. 5,143,582 to Arkens et al.

Despite advances in the prior art, there still remains a need for high strength polyvinyl acetate binders that are polymerized at low pressures. Accordingly, there is provided in the present invention low pressure polymerized, polyvinyl acetate type emulsion binders that can provide high strengths to fibrous substrates. The properties of the inventive PVAc binders make them especially suitable as a binder in fiberfill or wadding-type applications where higher strength and stiffness is desired.

### SUMMARY OF THE INVENTION

The binder compositions of the present invention provide excellent tensile strength properties to fibrous substrates and exhibit superior curing behavior, such as good heat stability and a high crosslinking density. Additionally, the aqueous emulsions have a low viscosity which makes them easier to process and handle. Various aspects of the invention are summarized below and described in detail thereafter.

According to one aspect of the present invention there is provided an emulsion binder composition for fibrous substrates where the binder composition includes water and an emulsion resin which comprises from 50 pphwm to 100 pphwm vinyl acetate monomer units and from 4 to 15 pphwm post-crosslinking monomer composition, where the emulsion resin is polymerized at a pressure of less than 250 psi. The inventive binder composition provides a characteristic dry cross-machine direction tensile strength of at least about 10,000 gf/in, when measured according to the CMD test defined below. Preferably, the high strength binders of the invention provide cross-machine direction tensile strengths of greater than 11,000 gf/in or even greater than 11,500 gf/in.

The binder compositions also generally provide machine direction tensile strength values of at least 6,000 psi, when measured according to the MD test, described in greater detail below. In preferred embodiments, the binder compositions provide machine direction tensile strength values of greater than 6,500 psi, 7,000 psi, or greater than 8,000 psi.

The inventive binder compositions also typically exhibit air dried insolubles levels of greater than about 45 percent, and more typically greater than about 50 percent or about 60 percent. The binders may exhibit cured insolubles levels of at least about 85 percent, and in preferred embodiments of at least about 90 percent.

The aqueous emulsion binders also have low viscosities, such that they exhibit a viscosity of less than 750 cps when measured at 23° C. and a solids level of about 45 percent.

The emulsion resin in the binder compositions may have a glass transition temperature in the range of 15° C. to 45° C., with a preferred range being from 25° C. to 40° C. The emulsion resin includes vinyl acetate monomer in the following preferred ranges 85-100 pphwm, 95-100 pphwm, and 97-100 pphwm. Generally the emulsion resin is substantially free of ethylene. As such, the polymer is typically polymerized at a pressure of no more than 100 psi, and usually at a pressure of 50 psi or less. In most embodiments, the emulsion polymer is polymerized at approximately atmospheric pressure.

The resin may include post-crosslinking monomer composition in amounts of from 5-10 pphm; the post crosslinking monomer composition typically includes N-methylol acrylamide, and in preferred embodiments consists essentially of a blend of N-methylol acrylamide and acrylamide.

Other ethylenically unsaturated monomers may be included in the emulsion resin in amounts of from 0.1 to 50 pphwm, and preferably from 0.1 to 10 pphwm. When used, the additional ethylenically unsaturated monomers units may comprise acrylates or alkyl esters of maleic acid. In some embodiments, the additional monomers may include vinyl esters of Verasatic acid, preferably VeoVa™ 9 or VeoVa™ 10, which are available from Resolution Performance Products, LLC (Houston, Tex.).

In some embodiments of the invention, the binder composition is substantially free of alkylphenol ethoxylated (“APE”) surfactants.

There is also contemplated a fibrous substrate that includes the dried binder composition of the invention. The fibrous substrate may include fiberfill, fiberpad, nonwovens, needle punched carpet, and other textile products.

In another aspect of the present invention there is provided fiberfill which comprises synthetic fibers and an emulsion binder, where the emulsion binder includes a polymer having from 90 to 100 pphwm vinyl acetate and from 4 to 15 pphwm of post-crosslinking monomer composition. The emulsion binder exhibits an air-dried insolubles level of at least 45 percent. The fiberfill may also be substantially free of pre-crosslinking monomers. Preferably, the emulsion binder provides a characteristic fiberfill MD tensile strength of at least about 4 lbf/in, and a characteristic fiberfill CMD tensile strength of at least about 3 lbf/in, when measured according to the Fiberfill Tensile test described below.

The emulsion binder used in the fiberfill may be cured at a curing temperature of at least about 265° F., and the fiberfill typically should not exhibit yellow discoloration.

There is also provided according to the invention a filter medium that includes fiberfill produced according to the invention.

In yet another aspect of the invention there is provided a method of making an aqueous emulsion binder by the steps of i) emulsion polymerizing a reaction mixture at approximately atmospheric pressure, where the mixture includes (A) 50-100 pphwm vinyl acetate, (B) 4-15 pphwm post-crosslinking monomer, and (C) a redox initiating system; ii) slow-adding components (A), (B), and (C) concurrently with the polymerization; and iii) controlling the amounts and addition rates of (A), (B), and (C), and controlling the reaction temperature, such that the binder composition exhibits an air-dried insolubles level of at least 45 percent. The amounts and addition rates of (A), (B), and (C), and the reaction temperature are preferably controlled such that the emulsion binder also provides a characteristic dry cross machine direction tensile strength of at least about 10,000 gf/in. The redox initiating system may include a hydrophobic oxidizing agent.

The emulsion binders produced according to the inventive method typically have a solids content of from 40 to 60 percent. The emulsions also generally exhibit a viscosity of less than 750 cps, preferably less than 500 cps, when measured at a solids content of about 45 percent. The emulsion resin generally has a particle size of from 200 to 350 nm.

Still further features and advantages of the invention are apparent from the following description.

### DETAILED DESCRIPTION OF THE INVENTION

The invention is described in detail below with reference to numerous embodiments for purposes of exemplification and illustration only. Modifications to particular embodiments within the spirit and scope of the present invention, set forth in the appended claims, will be readily apparent to those of skill in the art.

Unless more specifically defined below, terminology as used herein is given its ordinary meaning.

“Add-on” refers to the amount of binder that is added to the fibrous web and is calculated according as follows:

$$Add \text{-} on \% = \frac{Combined binder \text{/} fiber wt . - Fiber wt .}{Combined binder \text{/} fiber wt .} \times 100 \%$$

where the binder/fiber wt. is the weight of the web and binder after substantially all of the water is removed by drying/curing.

The insolubles level relates to the degree of crosslinking achieved by the binders. The “air-dried insolubles” level is measured on films of the binder that have been air-dried for 24 hours at 23° C. Likewise, the “cured insolubles” level of a binder is measured on films of the binder that have been cured for 90 seconds at 150° C. (after the 24 hours air-drying period). In both cases, the insolubles level is determined as is set forth in the examples below; that is, by measuring the residual weight of a 6 mil film sample after boiling in acetone for 2 hours.

The “characteristic dry cross-machine tensile strength” provided by a binder refers to the dry tensile strength when tested under the standardized conditions that are set forth in Examples 11-14, below; the procedure is referred to herein as the “CMD test”. Accordingly, the average tensile strength is tested on six 1×5″ strips cut in the cross-machine direction (“CMD”) of Whatman #4 Chromatography paper, having about 20% binder add-on, where the samples are drum dried for 90 seconds at 210° F., and cured for 2 minutes at 325° F. The samples are tested using an Instron device set at a 3″ gauge length with a crosshead speed of 1 inch/min. The characteristic CMD tensile strength is reported in gf/in. In addition to the characteristic dry CMD strength, the samples may be tested for characteristic wet CMD tensile strength by soaking the sample for 1 minute in water or a 1% solution of surfactant.

The “characteristic dry machine direction tensile strength” provided by a binder refers to the tensile strength that the binder provides to a standard web when tested under the standard conditions that are set forth in Examples 1-10 below; the procedure is referred to herein as the “MD test”. Specifically, the average machine direction (“MD”) tensile strength is measured on six 1×6″ samples which are cut in the machine direction of Whatman #4 Chromatography paper, having about 18% binder add-on, and that are cured at 150° C. for 3 minutes. The samples are tested using an Instron device set at a 2″ gauge length with a crosshead speed of 12 inches/min. For the MD test, the thickness of the samples is measured, and used to calculate the tensile strength in psi, where the peak force in pounds is divided by the width of the material in inches and by the thickness of the sample in inches.

The tensile strength properties of the binder may also be tested on standardized fiberfill substrates. This property, for the purposes of this invention, is called the “characteristic dry fiberfill tensile strength” (either CMD or MD) and is measured as outlined in Examples 15A-16C, below. According to that procedure, which is called the “fiberfill tensile test,” either the CMD or MD strength is measured on standardized fiberfill substrates which have a batt weight of approximately 5 oz/sq.yd. and a thickness of about 1″, where the binder is present at an add-on of about 29 percent and is cured at a curing temperature of about 280° F. The tensile strength values are measured on an Instron device that is set at a gauge length of 2″ and a traverse rate of 12″/min. For the Fiberfill Tensile test, the tensile strength is reported as lbf/in, i.e., the pounds at the sample break is divided by the width of the sample (1 inch wide).

“Parts per hundred weight monomer,” or “pphwm”, refer to the mass of a reaction component per 100 parts mass of the major monomers in the polymer or reaction mix. The crosslinking monomer and other adjuvants are not considered a ‘major monomer’ for the purposes of calculating the pphwm. In the present invention, the major monomer is primarily vinyl acetate but may also include additional ethylenically unsaturated monomers that are present in lesser amounts, such as, for example, other vinyl esters, acrylates or alkyl esters of maleic acid.

“Slow-add,” “slow-addition,” and the like, refers to the gradual addition of an amount of a reaction component to the reactor vessel during the course of the polymerization. Usually, the addition rate is controlled such that the component is added over a period of at least an hour, and more typically at least 3 hours.

The binder compositions of the present invention comprise low pressure polymerized emulsion polymers having predominantly vinyl acetate monomer units, and a minor amount of post-crosslinking monomer composition. The vinyl acetate monomer should be present in amounts of at least 50 pphwm. In most embodiments the vinyl acetate is present in amounts ranging from 85-100 pphwm, 95-100 pphwm, or even 97-100 pphwm.

The post-crosslinking monomer composition employed in the emulsion polymer of the invention reacts with itself upon drying/curing, allowing the binder composition to provide strength to a fibrous substrate. The post-crosslinking monomer composition should be present in amounts ranging from 4 pphwm to 15 pphwm, and preferably from 5 to 10 pphwm. Post-crosslinking monomer compositions suitable in the present invention include N-methylol (meth)acrylamide and/or N-alkoxy methyl (meth)acrylamide compounds. Specifically, there is contemplated N-methylol acrylamide, N-methylol acrylamide, N-methylol allyl carbamate, iso-butoxy methyl acrylamide, n-butyoxy methyl acrylamide, or mixtures thereof. A preferred post-crosslinking monomer compostion is a blend of N-methylol acrylamide and acrylamide (acrylamide exhibits some crosslinking potential in the presence of other post-crosslinking monomers). The blend is commercially available as “NMA-LF” from Cytec Industries Inc. “NMA-IV” is an equivalent blend of N-methylol acrylamide and acrylamide.

The emulsion polymer suitably has less than 0.25 pphwm of pre-crosslinking monomers. More preferably the emulsion polymer has no pre-crosslinking monomers or is at least substantially free of pre-crosslinking monomers i.e., less than 0.1 pphwm. Pre-crosslinking monomers typically contain at least two vinyl groups, and can cause the polymer to crosslink before it is cured. Examples of pre-crosslinking monomers include divinyl benzene, allyl (meth)acrylate, diallyl phthalate, diallyl maleate, and triallyl cyanurate,

Ethylenically unsaturated monomers other than vinyl acetate or post-crosslinking monomers may be included in the emulsion polymer in amounts of less than about 50 pphwm, preferably less than 10 pphwm. The additional monomers may include other vinyl esters, acrylates, or alkyl esters of maleic acid. Particularly suitable monomers include butyl acrylate and dioctyl maleate. The additional monomers may also include vinyl esters of Versatic acid, which are commercially available as VeoVa™ monomers from Resolution Performance Products, LLC (Houston, Tex.). Although the choice of additional ethylenically unsaturated monomers is not particularly limited, the emulsion polymers in the present invention generally contain less than 5 pphwm ethylene. More preferably the emulsion polymers contain less than 1 pphwm, that is to say, they are substantially ethylene-free.

At least one emulsifying agent is present during the polymerization of the emulsion polymer. The emulsifier is present in an amount that is effective to maintain a stable aqueous emulsion of the copolymer as it polymerizes. Emulsifying agents may include surfactants and/or protective colloids. The emulsifiers may be either anionic, non-ionic, or cationic surfactants. Possible anionic surfactants include fatty acid soaps, alkyl carboxylates, alkyl surlates, alkyl sulfonates, alkali metal alkyl aryl sulfonates, alkali metal alkyl sulfates and sulfonated alkyl esters; specific examples include sodium dodecylbenzene sufonate, sodium disecondary-butylnaphtalne sulfonate, sodium lauryl sulfate, disodium dodecyidiphenyl ether disulfonate, disodium n-octadecylsulfosuccinate, sodium dioctyl sulfosuccinate, among others. Examples of suitable non-ionic emulsifiers are the addition products of 5 to 50 moles of ethylene oxide adducted to straight-chained and branch-chained alkanols with 6 to 22 carbon atoms, or alkylphenols, of higher fatty acids, or higher fatty acid amides, or primary and secondary higher alkyl amines; as well as block copolymers of propylene oxide with ethylene oxide and mixtures thereof. In some embodiments of the invention, the emulsion is substantially free of alkylphenol ethoxylate (“APE”) surfactants, i.e., less than 0.01 weight percent on a dry basis. Cationic surfactants include amines, nitriles, and other nitrogen bases; examples of cationic surfactants may include alkyl quaternary ammonium salts and alkyl quaternary phosphonium salts, such as: alkyl trimethyl ammonium chloride, dieicosyldimethyl ammonium chloride, didocosyldimethyl ammonium chloride, dioctadecyldimethyl ammonium chloride; dioctadecyldimethyl ammonium methosulphate, ditetradecyldimethyl ammonium chloride, and naturally occurring mixtures of above fatty groups, e.g., di(hydrogenated tallow) dimethyl ammonium chloride; di(hydrogenated tallow) dimethyl ammonium methosulfate, ditallow dimethyl ammonium chloride, and dioleyldimethyl ammonium chloride. Cationically modified polyvinyl alcohol and cationically modified starch may also be used as emulsifying agents. Preferably, the surfactants used in the present invention are primarily anionic and nonionic. A preferred anionic surfactant is Aerosol® A102 which is available from Cytec Industries Inc. A preferred nonionic surfactant is Igepal® CA-887 which is available from Rhone-Poulenc AG Company.

The protective colloids may also be used as a stabilizing agent. Examples of suitable protective colloids are polyvinyl alcohols, starch derivatives, and cellulose derivatives.

A redox initiator system is used to initiate the reaction. The choice of redox initiator is an important factor that affects the ability of the reaction to incorporate the post-crosslinking monomer on to the polymer backbone. The oxidizing agent should be hydrophobic. The hydrophobic oxidizing agents may include tert-butyl hydroperoxide, cumene hydroperoxide, t-butylperbenzoate, t-butyl 2 ethyl perhexanoate, and combinations thereof. Tert-butyl hydroperoxide is preferred. Additional hydrophobic oxidizing agents which may be suitable are listed in U.S. Pat. No. 5,721,310 to Sempio et al., the disclosure of which is incorporated herein by reference. Suitable reducing agents of the redox initiator system include compounds such as, for example, sulfur compounds with a low oxidation state such as sulfites, hydrogen sulfites, alkali metal bisulfites, ketone adducts of bisulfites such as acetone bisulfite, alkali metal disulfites, metabisulfites and its salts, thiosulfates, formaldehyde sulfoxylates and its salts, reducing nitrogen compounds such as hydroxylamine, hydroxylamine hydrosulfate and hydroxylammonium salts, polyamines and reducing sugars such as sorbose, fructose, glucose, lactose and derivatives thereof, enediols such as ascorbic acid and isoascorbic acid, sulfinic acids, hydroxy alkyl sulfinic acids such as hydroxy methyl sulfinic acid and 2-hydroxy-2-sulfinacetic acid and its salts, formadinesulfinic acid and its salts, alkyl sulfinic acids such propyl sulfinic acid and isopropyl sulfinic acid, aryl sulfinic acids such as phenyl sulfinic acid. Sodium formaldehyde sulfoxylate is preferred. The redox initiators are generally used in combination with trace amounts of metal such as iron, which is preferably supplied as ferrous sulfate with a chelating agent such as Versene.

The polymerization may be carried out in an aqueous medium at a pH in the range of 3 to 5. To maintain the pH of the reaction mix, a buffer may be added as is known in the art. Suitable buffers include alkali metal acetates, alkali metal carbonates, and alkali metal phosphates. The reaction medium should be predominantly water, although other solvents may be present in minor amounts. The reaction is typically maintained at a relatively low reaction temperature, with suitable temperatures in the range of from 60° C. to 70° C.

Although polymerization procedures for vinyl acetate emulsion polymers are well known in the art, it has been surprisingly found that the polymerization procedure employed in the invention produces binder compositions that have unexpectedly high strength capabilities and exhibit excellent curing properties. Without intending to be bound by any theory, it is believed that the use of the hydrophobic oxidizing agent and lower polymerization temperatures are important factors in the ability of the procedure to incorporate the crosslinking monomer into the polymer backbone. The choice of redox initators may allow the reaction to be maintained at a lower temperature which, in turn, enables the process to achieve a controlled conversion rate. And, when the crosslinking monomer is slow-added concurrently with redox initators and vinyl acetate, it is incorporated onto the backbone at a more constant rate. This prevents crosslinking monomers from polymerizing with themselves and, for example, entering the water phase of the emulsion. It also promotes an even distribution of the crosslinking monomer on the polymer backbone.

It is further unexpected that this approach is effective in low pressure polymerizations of vinyl acetate polymers, i.e., pressures lower than 250 psi. The reaction of the present invention is desirably performed at pressures less than 100 psi, less than 50 psi, and more preferably at substantially atmospheric pressure, that is 14.7+/−10 psi. A more detailed description of the polymerization procedure is illustrated in the examples below.

The inventive binder compositions are generally provided as an aqueous emulsion which consists primarily of water and the vinyl acetate polymer. The solids content of the aqueous emulsion is generally from about 35 to 65 percent, more particularly from 40 to 60 percent; however the emulsions may be diluted or concentrated to any solids level depending on the desired application.

The aqueous emulsions of the invention generally have a viscosity of less than about 750 cps at 23° C. when measured at a solids content of about 45%. Preferably the viscosity is less than 500 cps. The low viscosity achieved by the inventive compositions is unique for polyvinyl acetate emulsions with high levels of crosslinking monomer because conventional polymerization procedures cause the crosslinking monomer to enter the water phase when present in high amounts, resulting in a rapid increase in viscosity.

The emulsions produced generally have a particle size of from 100 to 500 nm, with a preferred particle size being from 200 to 350 nm. The glass transition temperature of the polymer is typically in the range of 15 to 45° C., and desirably in the range of 25° C. to 40° C.

Generally, the aqueous emulsion is applied to a fibrous substrate and either air-dried or cured to crosslink the binder composition. Latent acid catalysts may also be combined with the binder composition to improve the curing time of the post-crosslinking monomer. Suitable acid catalysts include mineral acids such as hydrogen chloride; organic acid, such as oxalic acid; or acid salts such as ammonium chloride or ammonium phosphate. When used, the acid is typically present in amounts of about 0.2 to 5 percent of the total solids weight of the binder.

The binder compositions of the present invention exhibit excellent strength properties, and generally have characteristic dry cross-machine tensile strength values (measured according to the CMD test, above) of at least 10,000 gf/in, and preferably at least 11,000 gf/in, or at least 11,500 gf/in. Also, the binders of the invention typically provide characteristic dry machine direction tensile strengths (as measured according to the MD test) which exceed values of 6,000 psi, and more preferably greater than 8,000 psi. The high strength properties allow the manufacturer to provide fibrous substrates with higher strength values or, alternatively, less binder may be used to provide the same strength; thus, saving the costs of the binder.

The binder compositions of the present invention also achieve a high crosslinking density, as is measured by the level of insolubles in films made from the binder compositions. Typically, the polymers exhibit an air-dried insolubles level of at least about 45 percent, at least about 55 percent, and more preferably at least about 60 percent. When air dried and then cured at 150° C. for 90 seconds, the polymers exhibit a cured insolubles level of greater than 85 or 90 percent. These values indicate that a high fraction of the total polymer is incorporated into the network after it is dried/cured.

Advantageously, the polymers also generally exhibit good heat stability as is evidenced by a low level of film discoloration when subjected to elevated temperatures. Generally it is considered desirable for the binder to exhibit a clear color after the cure. Poor heat stability is evidenced by yellowish discoloration.

Applicants have discovered that the inventive compositions are particularly suitable as binders for synthetic fiberfill, batting, wadding and the like. Fiberfill is commonly used as filling and/or insulating material for pillows, curtains, bedding materials, and apparel. Fiberfill generally consists of synthetic polyester fibers. The polyester fibers are typically hollow fibers made from polyethylene terephthalate. Fiberfill products can be made with other fibers, e.g., polyamide, cellulose acetate, rayon, glass, alone or in blends. In some embodiments, a meltable binder fiber may be included in the fiberfill. The fibers may also be crimped as is well known in the art.

Preparation of the fiberfill batts is generally begun by conventional opening and blending of the polyester fiber and optionally a meltable binder fiber, followed by carding or garnetting to make a web. The most common construction of a fiberfill product is a loosely garnetted, cross-lapped or air laid web of 6 to 30 denier polyester staple fibers which is bonded with the polymeric binder. The web can be layered with other webs from a train of cards or garnets, or it can be cross lapped and combined with other webs to form an unbonded batting.

After batting, the fibers are bonded by applying the emulsion polymer binder. The emulsion binders may be added to the fibrous substrates by spraying. Application methods such as frothing/foaming, saturation, or other known techniques, may also be used. The emulsion is usually spray applied at a solids level of about 20 to 30 percent. The fiberfill batt is processed through a “3-pass oven” as is known in the art, where the fiberfill batt is sprayed with binder on both sides, and cured at temperatures of between about 200-300° F., and typically from 265-300° F. Alternative drying/curing procedures include contacting the fibrous substrate with a hot metal drum or a hot calendar stack.

Specific processes and materials for making bonded fiberfill substrates are disclosed in U.S. Pat. No. 3,772,137 to Tolliver; U.S. Pat. No. 4,068,036 to; U.S. Pat. No. 4,129,675 to Stanistreet; U.S. Pat. No. 4,281,042 to Scott; U.S. Pat. No. 4,304,817 to Frankosky; U.S. Pat. No. 4,551,383 to Siniscalchi; U.S. Pat. No. 4,869,771 to LeVan; and U.S. Pat. No. 5,225,242 to Frankosky et al., the disclosures of which are incorporated herein by reference.

The bonded fiberfill batts of the invention exhibit desirable properties such as high tensile strength, excellent color, and good recovery and washability, as is illustrated in more detail in examples 16A-C below. For instance, fiberfill batts provided with the inventive binder generally exhibit cross-machine direction tensile strength values of greater than 3 lbf/in, when measured according to the Fiberfill Tensile test described in examples 15A-16C (Table 6). The MD tensile strength values of the bonded fiberfill batts are typically greater than 4 lbf/in, and preferably greater than 4.5 lbf/in. Also, there is usually no yellow discoloration of the batts after curing. The fiberfill batts also generally exhibit a short term compression recovery of at least 90 percent, and a long term compression recovery (24 hour recovery) of at least about 70 percent.

While the inventive binder compositions have unique properties which make them especially suitable for fiberfill products, they may be used in numerous applications including fiber pads, nonwovens, needle-punched carpet, and other textile products. Fiberfill or nonwoven products made according to the invention are particularly useful as filter media in applications such as residential or commercial air and water filters, cab filters, and fish tank filters.

Further features of the invention are illustrated in the examples which follow.

### EXAMPLES

For purposes of illustration, the emulsion polymerization procedure which was used to polymerize a vinyl acetate/butyl acrylate/NMA (98.1/1.9/6 pphwm) polymer of the present invention is summarized below; the reaction mixes referred to are shown in Table 1, below.

Reaction mix A was added to a 2 L glass reactor and adjusted to a pH of 3.8-4.2 with phosphoric acid. The mix was then purged with nitrogen. The reactor temperature is slowly raised to 65° C. The reactor pressure remained at atmospheric pressure throughout the reaction. When the temperature reached 50° C., reaction mix A1 was added to the reactor. When the temperature reached 58° C., the slow-addition of reaction mixes C and D was started and continued for 4 hours 15 minutes. Five minutes after the temperature reaches 65° C., the slow-addition of reaction mix B was started and continued over while the temperature was maintained at 65° C. At the end of the slow-additions the reaction was held for 5 minutes. Mix E was subsequently added and blended for 5 minutes, then mix F was added over a period of five minutes. After 5 minutes of standing the reactor was cooled. The final emulsion had a pH of 4.9, a viscosity of 36 cps, and a solids content of 46.9%. The seed size was 141 nm. The particle size during the polymerization was as follows: 294 nm after 1 hour; 343 nm after 2 hours; 379 nm after 3 hours; and a final size of 386 nm.

TABLE 1

| | Reaction Mix | | | | | | |
|---|---|---|---|---|---|---|---|
| Component | pphwm | | | | | | |
| (% solids) | A | A1 | B | C | D | E | F |
| Water | 80.0 | | 12.0 | 10.0 | 9.0 | | 1.0 |
| (0%) | | | | | | | |
| Aerosol 102 | 0.50 | | 4.0 | | | | |
| (30%) | | | | | | | |
| SVS | 2.50 | | | | | | |
| (25%) | | | | | | | |
| Igepal CA- | 0.6 | | 1.4 | | | | |
| 887 | | | | | | | |
| (70%) | | | | | | | |
| Sodium | 0.02 | | 0.1 | | | | |
| Acetate | | | | | | | |
| (100%) | | | | | | | |
| SFS | 0.06 | | | | 0.29 | | 0.12 |
| (100%) | | | | | | | |
| t-BHP | | | | 0.44 | | 0.12 | |
| (70.0%) | | | | | | | |
| Versene 100 | 0.4 | | | | | | |
| (1.0%) | | | | | | | |
| Ferrous | 0.4 | | | | | | |
| Sulfate | | | | | | | |
| (1.0%) | | | | | | | |
| Vinyl | | 10.0 | 88.1 | | | | |
| Acetate | | | | | | | |
| (100%) | | | | | | | |
| Butyl | | | 1.99 | | | | |
| Acrylate | | | | | | | |
| (100%) | | | | | | | |
| NMA type | | | 12.5 | | | | |
| IV | | | | | | | |
| (48.0%) | | | | | | | |

### Examples 2-10

Examples 2-10 were polymerized using a procedure similar to the one described above, varying only the amount of monomer, the type of crosslinking monomer, and/or the reactor type (examples 6-10 were polymerized in a 17 gal. steel reactor). Control example 1 was produced using conventional processes. The compositions of Examples 1-10 are shown in Table 2, below.

TABLE 2

| | Reactor | | VA | NMA | NMA IV | BA | DOM |
|---|---|---|---|---|---|---|---|
| Example | Size | | (pphwm) | (pphwm) | (pphwm) | (pphwm) | (pphwm) |
| 1 (Control) | commercial | | 100 | 3.5 | — | — | — |
| | scale | | | | | | |
| 2 | 2 | L | 100 | 2.88 | — | — | — |
| 3 | 2 | L | 100 | 6 | — | — | — |
| 4 | 2 | L | 100 | 7 | — | — | — |
| 5 | 2 | L | 100 | 8 | — | — | — |
| 6 | 17 | gal. | 100 | — | 6 | — | — |
| 7 | 17 | gal. | 95 | — | 6 | 5 | — |
| 8 | 17 | gal. | 95 | — | 6 | — | 5 |
| 9 | 17 | gal. | 100 | — | 6 | — | — |
| 10 | 17 | gal. | 100 | — | 6 | — | — |

As described in detail below, the emulsion binders in Examples 1-10 were tested for baked color, film insolubles, and dry machine direction tensile strength properties.

To test the baked color of the emulsion polymer, a Coors dish is preheated for 5 minutes in a 150° C. Mathis thermosol oven. 5 drops of the emulsion are then placed in each of 4 wells in a row of the Coors dish and the dish is baked in the oven for 5 minutes. After 5 minutes, drops of the test polymer are added to the next row of the Coors dish in the same manner as above. The dish is baked again for 5 minutes and the coloration of the polymer is observed for 5 minutes and 10 minutes of baking time. A rating of “Excellent” refers to a clear composition, while a rating of “Good” or “Fair” corresponds to an increasingly yellow discoloration.

To test for film insolubles, a 6 mil film of the test polymer is cast on a glass plate. For air-dried insolubles the film is allowed to air dry for 24 hours. To test for cured insolubles, the film is air-dried for 24 hours and then cured for 90 seconds at 150° C. 0.5 grams of film are weighed to the nearest 0.1 mg into a 250 ml Erlenmeyer flask. Boiling stones and 100 ml of acetone are added to the flask. The sample is refluxed for 2 hours and then allowed to cool. 20 ml of the filtered refluxed solutions are pipetted into a tared weighing dish, and the acetone is evaporated leaving the soluble polymer which is identified as the residual weight. Duplicate samples are measured. The insolubles level is calculated as follows:

$$\% Insolubles = [ 1 - ( \frac{Residual Weight \times 5}{Initial Film Weight} ) ] \times 100$$

The procedure for measuring the characteristic dry MD tensile strength that is provided by the binders is conducted as follows (referred to herein as the MD test): 1×12 inch strips of Whatman #4 CHR chromatography paper (commercially available from Whatman, Inc.) are cut in the machine direction. The emulsion binder is adjusted to a pH of 3.2 with phosphoric acid and, if necessary, the emulsion solids are adjusted to provide binder add-on values of about 18%. The strips are then dip-nip saturated by passing the pulp through a bath of the emulsion binder and then passing the saturated sheets through the pressurized nip rolls of a dual roller saturator set at a pressure of 5.0 psi (Werner Mathis VFM or a similar saturator) to squeeze off the excess emulsion polymer. The prepared strips are then dried/cured for 3 minutes at 150° C. The strips are cut into 1×6 inch specimens and allowed to condition at a controlled temperature (72° C.) and humidity (65%). The thickness of the specimens is measured, which is used to calculate the tensile strength in psi. The tensile strength is measured on the Instron tensile device, set at 2 inch gauge length and a traverse rate of 12 inches per minute. The Instron is pulled to the break point and the peak tensile strength is reported in psi, which is calculated by dividing the maximum force in pounds by the sample width in inches and by the sample thickness in inches. The charactertic tensile strength is the average value of at least 6 tests.

The results of the tensile strength, insolubles and color tests are shown in Table 3, low.

TABLE 3

| | | Air Dried | Cured | |
|---|---|---|---|---|
| | | Film | Insolubles, | MD Tensile |
| | | Insolubles | 90 s at 150° C. | Strength |
| Example | Baked Color | (%) | (%) | (psi) |
| 1 | Good/Fair | 13.0 | 92.9 | 6472 |
| (Control) | | | | |
| 2 | Excellent | 58.0 | 84.5 | 5963 |
| 3 | Excellent | 63.8 | 90.1 | 6418 |
| 4 | Excellent | 58.2 | 89.5 | 6407 |
| 5 | Excellent | 62.7 | 94.0 | 6428 |
| 6 | Excellent | 52.8 | 90.5 | 6716 |
| 7 | Excellent | 67.5 | 92.6 | 7112 |
| 8 | Excellent | 60.1 | 93.4 | 7326 |
| 9 | Excellent | 62.3 | 92.9 | 8202 |
| 10 | Excellent | 61.2 | 90.8 | 8094 |

As can be seen in the above examples, the binder composition of the present invention can readily provide MD tensile strength values of over 8,000 psi. Additionally, the air-dried insolubles and the cures insolubles reach remarkably good levels compared to polymers that are produced according to conventional methods.

### Examples 11-14

The compositions of Examples 11-14 are shown in Table 4, below. Examples 11 and 12 (comparative) are EVA copolymers that were produced according to the procedure described in copending application no. 2003/0176133 to Walker et al. Examples 13 and 14, were produced by the procedure outlined above, except the monomer amounts were changed as indicated.

TABLE 4

| | VA | Ethylene | NMA | |
|---|---|---|---|---|
| Example | (pphwm) | (pphwm) | (pphwm) | Latent Acid Catalyst |
| 11 (Comp.) | 82 | 18 | 8 | None |
| 12 (Comp.) | 82 | 18 | 8 | 0.85% (mono) |
| | | | | ammonium phosphate |
| 13 | 100 | — | 6.4 | 0.85% (mono) |
| | | | | ammonium phosphate |
| 14 | 100 | — | 6.4 | 1.0% ammonium |
| | | | | chloride |

The binders in Examples 11-14, were tested for characteristic cross machine direction strength. The procedure for measuring the characteristic dry cross machine direction tensile strength that is provided by the binders is conducted as follows (referred to herein as the CMD test): 1×12 inch strips of Whatman #4 Chromatography paper are cut in the cross-machine direction. The emulsion binder is adjusted to a pH of 3.2 with phosphoric acid and, if necessary, the emulsion solids are adjusted to provide binder add-on values of about 20%. The strips are then dip-nip saturated, as described above. The prepared strips are then drum dried for 90 seconds at 210° F., and cured for 2 minutes at 325° F. Six 1×5 inch specimens are then cut in the cross-machine direction and are then allowed to condition at a controlled temperature (72° C.) and humidity (65%). Tensile strength is measured on a standard Instron tensile tester, set at 3 inch gauge length and a traverse rate of 1 inch per minute. Where the test conditions indicate, the wet tensile strengths of the strips are measured after the strips are soaked for 1 minute in a 1% solution of Aerosol OT. The characteristic tensile strength is the average value of at least 6 tests, reported in gf/in. Note, that although the CMD test does not take into account the thickness of the Whatman substrate, the thickness will not vary significantly when the standardized substrate is provided with the specified amount of binder as noted above.

TABLE 5

| | | Sheet | | | | CMD | |
|---|---|---|---|---|---|---|---|
| | | Basis | | Peak | Std. | Tensile | Std. |
| | Add-on | Weight | | Elg, | Dev. | Strength | Dev. |
| Ex. | (%) | (gsm) | Test Conditions | (%) | (%) | (gf/in) | (gf/in) |
| 11 | 20.2 | 115.9 | Dry | 9.4 | 0.3 | 9249 | 216 |
| | | | 1% solution of | 14.0 | 0.3 | 4933 | 78 |
| | | | Aerosol OT | | | | |
| 12 | 20.2 | 116.8 | Dry | 9.5 | 0.6 | 9465 | 180 |
| | | | 1% solution of | 13.3 | 0.3 | 5089 | 144 |
| | | | Aerosol OT | | | | |
| 13 | 20.4 | 117.1 | Dry | 6.6 | 0.6 | 11709 | 199 |
| | | | 1% solution of | 14.9 | 0.7 | 5334 | 70 |
| | | | Aerosol OT | | | | |
| 14 | 20.1 | 116.4 | Dry | 6.8 | 0.4 | 11723 | 124 |
| | | | 1% solution of | 13.9 | 0.7 | 5219 | 89 |
| | | | Aerosol OT | | | | |

As can be seen from Table 5, the inventive vinyl acetate resins have an improved dry CMD strength of approximately 25% over the ethylene vinyl acetate resins. This is surprising, especially considering that the CMD wet strength values of the inventive binders are comparable.

### Examples 15A-16C

Examples 15A-C (Comparative) and Example 16A-C below illustrate the properties of the vinyl acetate polymer on a fiberfill batting. The binder in Examples 15A-C is a self crosslinking vinyl acetate homopolymer emulsion that is prepared according to conventional processes using a persulfate thermal initiation system. Example 15 contains 3.5 pphwm of NMA. The composition in Examples 16A-C is a self-crosslinking vinyl acetate homopolymer prepared according to the inventive process described above, and has an NMA content of 5.2 pphwm.

The emulsion resin in each example was applied to a fiberfill batt and cured at three different temperatures, as is shown in Table 6 below. The fiberfill webs were prepared by the Carlee Corporation (Rockleigh, N.J.), and comprise polyester fiber (PET) batting having a batt weight of about 5 oz/sq.yd and a thickness of about 1″. The fiberfill batts are passed through a 3-pass oven having two spray stations, where the emulsion binder is sprayed on each side of the fiberfill batt. The oven includes three zones, where the last zone represents the curing temperature; the zone temperatures (actual temps.) are shown in Table 6. The basis weight, add-on , tensile strength, and % cure was measured for each example as is shown below in Table 6.

The procedure for measuring the dry fiberfill tensile strengths that are provided by the binders is conducted as follows (referred to herein as the Fiberfill Tensile test): The bonded Carlee fiberfill batts (approx. 5 oz/sq.yd. and 1″ thick) are cut into several 1″ wide samples in either the machine or cross machine direction, as indicated. The tensile strength is tested on an Instron Tensile Tester, Model 1130 Series, where the device is pulled to the break point and the record peak tensile strength is recorded in pounds. The Instron device is set at a gauge length of 2″ and a traverse rate of 12″/min. The reported tensile strength is the average of at least 6 samples. The “characteristic dry fiberfill tensile strength” refers to samples that are cured at a curing zone temperature of 280° F. Note, the tensile strength units are expressed in lbf/in, i.e., the pound force at sample break is divided by the width of the sample (1 inch wide). The tensile strength is reported as lbf/in rather than psi, as above, due to variations in the dimensions of the batt samples.

The % cure of the bonded fiberfill is calculated subsequent to determining the % binder add-on, where add-on is the difference of the weight of the bonded fiberfill before and after removal of the binder by extraction in hydrochloric acid. The extraction procedure is described as follows: Approximately 1.5 grams of bonded fiberfill is weighed to an accuracy of 0.0001 g. The 1.5 gram specimen is placed into a beaker containing 200 mls of hydrochloric at 35C. The specimen is allowed to remain in the hydrochloric acid for one hour, and then neutralized in a 3% solution of sodium bicarbonate. Upon rinsing thoroughly, the extracted specimen is squeezed by hand of excess water, placed on a paper towel, and placed in a 130° C. oven and dried for 2 hours.

$$\% Add \text{-} on = \frac{Combined binder \text{/} fiber wt . - Fiber wt .}{Combined binder \text{/} fiber wt .} \times 100$$

The % cure is measured according to the following procedure (comparable to the Cured Insolubles test, noted above): 150 ml of acetone is added to an Erlenmeyer flask. Approximately 1.5 g of bonded fiberfill is added to a Soxhlet and placed on top of the flask. The flask contents are refluxed for 2 hours and allowed to cool for approximately 30 minutes. The fiberfill is then placed on a paper towel and dried in an oven for 2 hours at 130° C. The fiberfill is cooled in a desiccator and weighed. The percent cure is calculated as follows:

$$\% Cure = [ 1 - ( \frac{Weight of Soluble Binder}{ \begin{matrix}Bonded Fiberfill Weight Before Reflux \times \\ 0.01 \times Percent Add \text{-} on\end{matrix}} ) ] \times 100$$

where the weight of soluble binder is the difference between the weight of the bonded fiberfill before reflux and the weight of the fiberfill after reflux.

TABLE 6

| | | | | | MD | CMD |
|---|---|---|---|---|---|---|
| | Oven Zone | Batt | | | Fiberfill | Fiberfill |
| | Temp. | weight | % Add- | | Strength | Strength |
| Ex. | (° F.) | (oz./sqyd) | on | % Cure | (lbf/in) | (lbf/in) |
| 15A | 220/240/250 | 4.8 | 28.5 | 64.0 | 2.340 | 1.478 |
| 16A | 220/240/250 | 5.2 | 27.3 | 62.4 | 3.020 | 2.350 |
| 15B | 260/250/250 | 5.2 | 28.6 | 82.0 | 3.030 | 2.000 |
| 16B | 260/250/250 | 5.2 | 29.0 | 68.1 | 4.410 | 3.830 |
| 15C | 260/260/280 | 5.1 | 26.9 | 88.6 | 3.930 | 3.180 |
| 16C | 260/260/280 | 5.1 | 30.1 | 84.4 | 4.830 | 3.310 |

Table 6 illustrates that fiberfill batting can also be supplied with superior strength values by applying the binder of the invention. As can be seen, the strength values for examples 16A-C are remarkably higher than for batts that have a conventional binder—in some cases, the inventive binder improves the MD strength by more than 45% and the CMD strength by over 90%.

Examples 15A-16C were also tested for wash durability according to the following procedure: 12″×12″ samples of the bonded fiberfill are sewn between an 80×80 cotton print cloth face fabric and a tricot backing. The edges of the composite are double stitched. The samples are then washed in a standard domestic washing machine using warm water (120° F.-140° F.) and towels as a ballast. Five wash cycles are repeated (no drying). In between cycles, the composite is cut to expose the fiberfill and the samples are rated based on bunching and pilling in reference to photographic standards in ASTM D 13.61.02. A number is assigned to qualify the durability of the fiberfill sample; a “5.0” indicates high durability and a “1.0” indicates low durability. The results are shown in Table 7, below.

TABLE 7
Wash Durability

| Example | Cycle 1 | Cycle 2 | Cycle 3 | Cycle 4 | Cycle 5 |
|---|---|---|---|---|---|
| 15A | 5.00 | 4.25 | 4.00 | 2.50 | 1.00 |
| 16A | 5.00 | 3.00 | 3.00 | 1.00 | 1.00 |
| 15B | 5.00 | 4.50 | 4.50 | 3.25 | 1.50 |
| 16B | 5.00 | 4.50 | 4.50 | 2.50 | 1.00 |
| 15C | 5.00 | 5.00 | 4.50 | 3.50 | 2.50 |
| 16C | 5.00 | 5.00 | 4.00 | 4.00 | 3.00 |

Examples 15A-16C were further tested for compression recovery according to the following procedure: The bonded fiberfill batt is conditioned for 24 hours at standard climate conditions. Several 4.5″×4.5″ samples are cut from the batt and are stacked to a height of 12 inches in a compression recovery box. An unweighted plunger is placed on the stack for 5 minutes and then removed. The stack is allowed to recover for 5 minutes. The height is then measured on all four sides and the measurements are averaged. The average is recorded as h₀. A weighed plunger (total weight of 3.75 lbs) is placed on the stack batting from the designated compression time. The compressed height is measured and the average is recorded as h₁. The weighted plunger is removed and the stack is allowed to recover for the indicated time. The average of the recovered height is recorded as h₂. The compression recovery is calculated as follows:

$$Percent Recovery = ( \frac{{h}_{2} - {h}_{1}}{{h}_{0} - {h}_{1}} ) \times 100$$

The compression test is useful for determining whether the fiberfill will substantially retain its volume after shipping, where the fiberfill is vacuum packed prior to shipping. The recovery results for Examples 15A-16C are shown in Table 8, below.

TABLE 8
Compression Recovery

| | | | | | | Short |
|---|---|---|---|---|---|---|
| | | | | | | Term Recovery |
| | Long Term Recovery % | | | | | % (10 min. |
| | (24 hour compression) | | | | | compression) |
| | 0.5 hour | 1 hour | 2 hour | 4 hour | 24 hour | 15 min. |
| Example | recovery | recovery | recovery | recovery | recovery | recovery) |
| 15A | 58.60 | 62.80 | 69.40 | 70.30 | 75.20 | 89.40 |
| 16A | 65.20 | 66.00 | 69.20 | 70.80 | 76.00 | 96.00 |
| 15B | 66.20 | 68.00 | 71.50 | 75.10 | 80.40 | 94.60 |
| 16B | 58.90 | 63.70 | 67.70 | 68.60 | 90.70 | 91.00 |
| 15C | 60.80 | 61.70 | 64.20 | 75.00 | 75.00 | 94.00 |
| 16C | 62.30 | 63.50 | 68.70 | 73.00 | 78.30 | 92.00 |

Finally, the batting in examples 15A through 16C were tested for coloration. The results are shown in Table 9, below.

TABLE 9
Coloration

| Example | Coloration |
|---|---|
| 15A | Slight Discoloration |
| 16A | Excellent |
| 15B | Visible Discoloration |
| 16B | Excellent |
| 15C | Visible Discoloration |
| 16C | Excellent |

Tables 6-9, above, demonstrate that the binders of the invention (Examples 16A-C) provide superior strength and coloration properties to fiberfill batting, while not sacrificing (and in some cases improving) the wash durability and compression recovery.

While the invention has been illustrated in connection with several examples, modifications to these examples within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary.

What is claimed is:

1. An emulsion binder composition for fibrous substrates, wherein the binder composition includes:
i) water; and
ii) an emulsion resin which comprises from 50 pphwm to 100 pphwm vinyl acetate monomer units and from 4 to 15 pphwm post-crosslinking monomer composition, where the emulsion resin is polymerized at a pressure of less than 250 psi, and
wherein the binder composition provides a characteristic dry cross-machine direction tensile strength of at least about 10,000 gf/in (CMD test).

2. The binder composition according to claim 1, wherein the binder composition provides a characteristic dry cross-machine direction tensile strength of at least about 11,000 gf/in (CMD test).

3. The binder composition according to claim 1, wherein the binder composition provides a characteristic dry cross-machine direction tensile strength of at least about 11,500 gf/in (CMD test).

4. The binder composition according to claim 1, wherein the binder composition provides a characteristic dry machine direction tensile strength of at least 6,000 psi (MD test).

5. The binder composition according to claim 1, wherein the binder composition provides characteristic dry machine direction tensile strength of at least about 6,500 psi (MD test).

6. The binder composition according to claim 1, wherein the binder composition provides a characteristic dry machine direction tensile strength of at least about 7,000 psi (MD test).

7. The binder composition according to claim 1, wherein the binder composition provides a characteristic dry machine direction tensile strength of at least about 8,000 psi (MD test).

8. The binder composition according to claim 1, wherein the binder composition exhibits an air-dried insolubles level of at least about 45 percent.

9. The binder composition according to claim 1, wherein the binder composition exhibits an air-dried insolubles level of at least about 50 percent.

10. The binder composition according to claim 1, wherein the binder composition exhibits an air-dried insolubles level of at least about 60 percent.

11. The binder composition according to claim 1, wherein the binder composition exhibits a cured insolubles level of at least about 85 percent.

12. The binder composition according to claim 1, wherein the binder composition exhibits a cured insolubles level of at least about 90 percent.

13. The binder composition according to claim 1, wherein the binder composition exhibits a viscosity of less than 750 cps at 23° C., when measured at a solids level of about 45%.

14. The binder composition according to claim 1, wherein the emulsion resin has a glass transition temperature in the range of 15° C. to 45° C.

15. The binder composition according to claim 1, wherein the emulsion resin has a glass transition temperature in the range of 25° C. to 40° C.

16. The binder composition according to claim 1, wherein the emulsion resin comprises 85 to 100 pphwm vinyl acetate monomer units.

17. The binder composition according to claim 1, wherein the emulsion resin comprises 95 to 100 pphwm vinyl acetate monomer units.

18. The binder composition according to claim 1, wherein the emulsion resin comprises 97 to 100 pphwm vinyl acetate monomer units.

19. The binder composition according to claim 1, wherein the emulsion resin is substantially free of ethylene.

20. The binder composition according to claim 1, wherein the emulsion resin comprises from 5 to 10 pphwm post-crosslinking monomer composition.

21. The binder composition according to claim 1, wherein the post-crosslinking monomer composition comprises N-methylol acrylamide.

22. The binder composition according to claim 1, wherein the post-crosslinking monomer composition consists essentially of a blend of N-methylol acrylamide and acrylamide.

23. The binder composition according to claim 1, wherein the emulsion resin comprises from 0.1 to 50 pphwm of other ethylenically unsaturated monomer units.

24. The binder composition according to claim 1, wherein the emulsion resin comprises from 0.1 to 10 pphwm of other ethylenically unsaturated monomer units.

25. The binder composition according to claim 24, wherein the ethylenically unsaturated monomer units comprise acrylate monomers.

26. The binder composition according to claim 24, wherein the ethylenically unsaturated monomer units comprise alkyl esters of maleic acid.

27. The binder composition according to claim 24, wherein the binder composition is substantially free of alkylphenol ethoxylate surfactants.

28. The binder composition according to claim 1, wherein the emulsion resin is polymerized at a pressure of no more than 100 psi.

29. The binder composition according to claim 1, wherein the emulsion resin is polymerized at a pressure of no more than 50 psi.

30. The binder composition according to claim 1, wherein the emulsion resin is polymerized at approximately atmospheric pressure.

31. A fibrous substrate that includes the dried binder composition of claim 1.

32. The fibrous substrate of claim 31, wherein the fibrous substrate is selected from the group consisting of fiberfill, fiberpad, nonwoven, needle punched carpet, and other textile products.

33. Fiberfill comprising synthetic fibers and an emulsion binder, wherein said emulsion binder includes a polymer having from 90 to 100 pphwm vinyl acetate and from 4 to 15 pphwm of post-crosslinking monomer composition, and wherein the emulsion binder exhibits an air-dried insolubles level of at least 45 percent.

34. Fiberfill according to claim 33, wherein the binder composition provides a characteristic dry fiberfill CMD tensile strength of at least about 3 lbf/in (Fiberfill Tensile test).

35. Fiberfill according to claim 33, wherein the binder composition provides a characteristic dry fiberfill MD tensile strength of at least about 4.5 lbf/in (Fiberfill Tensile test).

36. Fiberfill according to claim 33, wherein said polymer is substantially free of pre-crosslinking monomers.

37. Fiberfill of claim 33 wherein the emulsion binder is cured at a curing zone temperature of greater than 265° F.

38. The fiberfill according to claim 33, wherein the fiberfill exhibits no yellow discoloration.

39. Filter media including the fiberfill of claim 33.

40. In a method of making an aqueous emulsion binder by emulsion polymerizing a reaction mixture in a reaction vessel, the improvement comprising:
i) polymerizing the reaction mixture at approximately atmospheric pressure and a reaction temperature, wherein the mixture includes (A) 50-100 pphwm vinyl acetate, (B) 4-15 pphwm post-crosslinking monomer, and (C) a redox initiating system;
ii) concurrently slow-adding components (A), (B), and (C) to the reaction vessel; and
iii) controlling the amounts and addition rates of (A), (B), and (C) and controlling the reaction temperature, such that the binder composition exhibits an air-dried insolubles level of at least 45 percent.

41. The improvement according to claim 40, wherein the amounts and addition rates of (A), (B), and (C), and the reaction temperature are further controlled such that the emulsion binder provides a characteristic dry cross machine direction tensile strength of at least about 10,000 gf/in (CMD test).

42. The improvement according to claim 40, wherein the redox initiating system comprises a hydrophobic oxidizing agent.

43. The improvement according to claim 42, wherein the hydrophobic oxidizing agent is selected from the group consisting of tert-butyl hydroperoxide, cumene hydroperoxide, tert-butyl perbenzoate, tert-butyl 2 ethyl perhexanoate, and combinations thereof.

44. The improvement according to claim 40, wherein the emulsion binder has a solids content of from 40 to 60 percent.

45. The improvement according to claim 40, wherein the emulsion has a particle size of from 200 to 350 nm.

46. The improvement according to claim 40, wherein the emulsion binder exhibits a viscosity of less than 750 cps at 23° C., when measured at a solids content of about 45%.

47. The improvement according to claim 40, wherein the emulsion binder exhibits a viscosity of less than 500 cps at 23° C., when measured at a solids content of about 45%.
